(19) United States
(12) Patent Application Publication
(10) Pub. No.: US 2025/0363388 A1
(43) Pub. Date: Nov. 27, 2025

(54) METHOD FOR TRAINING MODEL USING DATA PARALLELISM AND TERMINAL

(71) Applicant: SHENZHEN MEGACOMPUTE TECHNOLOGY CO., LTD, Shenzhen (CN)

(72) Inventors: Jinpeng LIU, Shenzhen (CN); Guiyuan SU, Shenzhen (CN)

(73) Assignee: SHENZHEN MEGACOMPUTE TECHNOLOGY CO., LTD, Shenzhen (CN)

(21) Appl. No.: 19/218,093

(22) Filed: May 23, 2025

(30) Foreign Application Priority Data
May 23, 2024 (CN) 202410650013.7
Dec. 31, 2024 (CN) 202411998647.8
Apr. 18, 2025 (CN) 202510495536.3

(51) Int. Cl. G06N 3/098; G06N 3/04

(52) U.S. Cl. CPC G06N 3/098; G06N 3/04

(57) ABSTRACT

A method for training a model based on data parallelism and a terminal. The model comprises local models trained at training terminals, respectively, and the method comprises: obtaining, by a first terminal, respective training losses of the training terminals; and calculating, by the first terminal, a weighted average of the training losses to obtain a weighted training loss, wherein the weighted training loss is for updating a parameter of the local model trained at each of the training terminals.

This application claims the priority to Chinese Patent Application No. 202410650013.7,titled “METHOD FOR TRAINING MODEL BASED ON DATA PARALLELISM AND RELATED DEVICE” and filed with the China National Intellectual Property Administration on May 23, 2024, Chinese Patent Application No. 202411998647.8, titled “METHOD FOR TRAINING MODEL AND RELATED DEVICE” and filed with the China National Intellectual Property Administration on Dec. 31, 2024, and Chinese Patent Application No. 202510495536.3, titled “METHOD FOR TRAINING MODEL USING DATA PARALLELISM, METHOD FOR TRAINING MODEL, AND RELATED DEVICES” and filed with the China National Intellectual Property Administration on Apr. 18, 2025, the entire contents of which are incorporated herein by reference in their entireties.

### FIELD

The present disclosure relates to the field of model training, and in particular to a method for training a model based on data parallelism, a terminal, and a non-transitory computer-readable storage medium.

### BACKGROUND

Large models with deep learning engender rapid and profound changes in various aspects of modern society, work, and daily life. It is no longer feasible to train models on a single computing device (such as a graphic processing unit, GPU) or a single computing node due to the increasing sizes (i.e., a quantity of parameters) of the models. Various parallel algorithms have been proposed in industry and academia to address the above issue, and the most representative algorithms are data parallelism, model parallelism (e.g., pipeline parallelism and tensor parallelism), or the like.

In conventional technology, training a large model is extremely costly. For example, training a large model with thousands or hundreds of billions of parameters requires hardware investment and daily maintenance, which can easily cost tens of millions or even hundreds of millions of US dollars. At present, how to improve efficiency of training large models has become an urgent problem.

### SUMMARY

A method for training a model based on data parallelism, a terminal, and a non-transitory computer-readable storage medium are provided according to embodiments of the present disclosure. Efficiency of model training is improved.

In a first aspect, a method for training a model based on data parallelism is provided. The model comprises local models trained at training terminals, respectively. The method comprises: obtaining, by a first terminal, respective training losses of the training terminals; and calculating, by the first terminal, a weighted average of the training losses to obtain a weighted training loss, where the weighted training loss is for updating a parameter of the local model trained at each of the training terminals.

In an embodiment, each of the training terminals obtains the respective training loss of said training terminals through: training a current version of the local model at said training terminal using training sub-data of said training terminal, where the training sub-data is a part of a current batch of training data, and the training loss of said training terminal is determined according to a predetermined loss function and a result of forward-propagating the training sub-data of said training terminal through the current version of the local model at said training terminal.

In an embodiment, the first terminal is one of the training terminals. Obtaining the respective training losses of the training terminals comprises: receiving the training sub-data of the first terminal; training the current version of the local model at the first terminal using the training sub-data of the first terminal to obtain the training loss of the first terminal; and receiving, from the training terminals other than the first terminal, the respective training losses of the training terminals other than the first terminal. The method further comprises: adjusting the current version of the local model at the first terminal with backpropagation according to the weighted training loss to obtain an updated version of the local model at the first terminal.

In an embodiment, the method further comprises: in response to determining that the current training terminal meets a predetermined aggregation condition, transmitting a parameter of the local model at the first terminal to an aggregating terminal, receiving an aggregated parameter transmitted from the aggregating terminal, where the aggregated parameter is a weighted average of respective parameters of all the local models, and the parameter of the local model at the first terminal is one of the parameters, and overwriting the parameters of the local model at the first terminal using the aggregated parameter.

In an embodiment, the first terminal is an aggregating terminal different from the training terminals. Obtaining the respective training losses of all the training terminals comprises receiving, from all the training terminals, the respective training losses of the training terminals. The method further comprises: transmitting the weighted training loss to each of the training terminals to enable said training terminal to adjust the current version of the local model at said training terminal according to the weighted training loss to obtain an updated version of the local model at said training terminal.

In an embodiment, the method further comprises: receiving, from each of the training terminals, a respective parameter of the local model at said training terminal; calculating a weighted average of the respective parameters of all the local models at the training terminals to obtain an aggregated parameter; and transmitting the aggregation parameter to each of the training terminals to enable said training terminal to overwrite the respective parameter of the local model at said training terminal using the aggregated parameter.

In an embodiment, the model comprises a plurality of network layers, a first layer among the plurality of network layers is deployed among respective first instances of the training terminals. The method comprises: obtaining respective backpropagated gradients of the first layer at the first instances of the training terminals; and calculating a weighted average of the backpropagation gradients to obtain a weighted gradient, where the weighted gradient is for calculating a gradient of a second layer among the plurality of network layers, the second layer is an immediately previous layer of the first layer along a direction of forward propagation, and the second layer is deployed on a single second instance of which layer parameters are shared by the local models of all the training terminals.

In an embodiment, the respective backpropagation gradient of the first layer at the first instance of each of the training terminals is a gradient of the weighted training loss with respect to: an input of the first layer at the first instance of said training terminal during forward propagation of the training sub-data of said training terminal through current version of the local model at said training terminal, where the input of the first layer is fed from the second layer.

In an embodiment, the gradient of the second layer is calculated through calculating a product of the weighted gradient and a Jacobian matrix of the second layer. Updating the parameter of the local model trained at each of the training terminals comprises: updating a parameter of the second layer using a parameter gradient (hereinafter called a gradient for short) of the second layer at the single second instance.

In an embodiment, the plurality of network layer further comprises a third layer and a fourth layer, the fourth layer is an immediately previous layer of the third layer in the direction of forward propagation, the third layer is deployed on a single third instance of which layer parameters are shared by the local models of all the training terminals, and the fourth layer is deployed among respective fourth instances of the training terminals. The method further comprises: calculating a gradient of the fourth layer at the fourth instance of each of the training terminals according to a backpropagated gradient of the third layer, where the backpropagated gradient of the third layer is a gradient of the weighted training loss with respect to an input of the third layer during forward propagation of the current batch of training data.

In an embodiment, the gradient of the fourth layer at the fourth instance of each of the training terminals is calculated at the fourth instance of said training terminal through calculating a product of the backpropagated gradient of the third layer and a Jacobian matrix of the fourth layer at the fourth instance of said training terminal. The method further comprises: updating a parameter of the fourth layer at the fourth instance of each of the training terminals using a parameter gradient (hereinafter called a gradient for short) of the fourth layer at the fourth instance of said training terminal.

In an embodiment, the third layer is the second layer, and the single third instance is the single second instance.

In a second aspect, a terminal is provided. The terminal comprises: a memory storing computer-readable instructions, and a processor. The computer readable instructions when executed by the processor implement a method comprising: obtaining respective training losses of training terminals, where the training terminals are configured to train local models, respectively, of a model; and calculating a weighted average of the training losses to obtain a weighted training loss, where the weighted training loss is for updating a parameter of the local model trained at each of the training terminals.

In a second aspect, a non-transitory computer-readable storage medium is provided. The non-transitory computer-readable storage medium stories computer-readable instructions. The computer readable instructions when executed by a processor implement a method comprising: obtaining respective training losses of training terminals, where the training terminals are configured to train local models, respectively, of a model; and calculating a weighted average of the training losses to obtain a weighted training loss, where the weighted training loss is for updating a parameter of the local model trained at each of the training terminals.

### BRIEF DESCRIPTION OF THE DRAWINGS

FIG. 1 is a schematic structural diagram of architecture of a system for implementing a method for training a model based on data parallelism according to an embodiment of the present disclosure.

FIG. 2 is a schematic flowchart of a method for training a model based on data parallelism according to an embodiment of the present disclosure.

FIG. 3 is a schematic diagram showing evaluation metrics of training a model comprising a convolutional network through a method according to an embodiment of the present disclosure.

FIG. 4 is a schematic diagram showing evaluation metrics of training a Transformer model through a method according to an embodiment of the present disclosure.

FIG. 5 is a schematic structural diagram of a training terminal according to an embodiment of the present disclosure.

FIG. 6 is a schematic structural diagram of an aggregating terminal according to an embodiment of the present disclosure.

FIG. 7 is a schematic structural diagram of a comparative framework according to an embodiment of the present disclosure.

FIG. 8 is a schematic structural diagram of a training framework according to an embodiment of the present disclosure.

FIG. 9 is a schematic flowchart of a method for training a model according to an embodiment of the present disclosure.

FIG. 10 is a schematic structural diagram of a training terminal according to another embodiment of the present disclosure.

FIG. 11 is a schematic structural diagram of a computer device according to an embodiment of the present disclosure.

### DETAILED DESCRIPTION OF THE EMBODIMENTS

Hereinafter technical solutions in embodiments of the present disclosure are described clearly and completely in conjunction with the drawings in embodiments of the present closure. Apparently, the described embodiments are only some rather than all of the embodiments of the present disclosure. Any other embodiments obtained based on the embodiments of the present disclosure by those skilled in the art without any creative effort fall within the scope of protection of the present disclosure.

A method for training a model based on data parallelism, a method for training a model, and related devices are provided according to embodiments of the present disclosure. Efficiency for model training is improved.

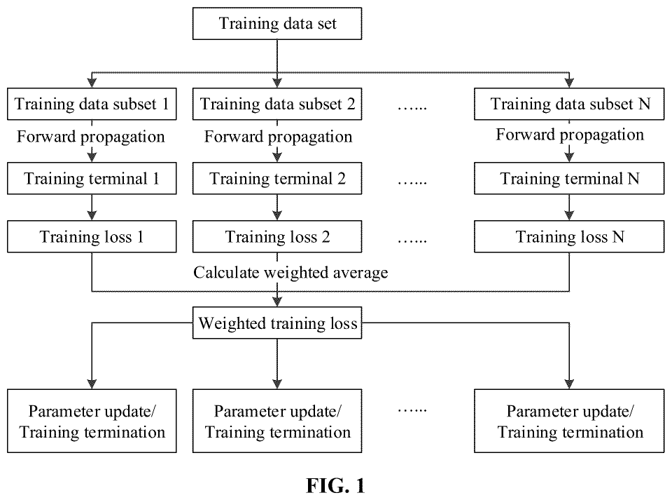

As shown in FIG. 1, architecture of a system for model training is provided according to an embodiment of the present disclosure to facilitate understanding of the training method based on data parallelism. As shown in FIG. 1, the architecture comprises multiple training terminals. Since the architecture is based on data parallelism, each training terminal (such as a current training terminal or another training terminal) participating in the training is embodied as one of multiple parallel units configured to implement a complete data parallelism scheme. In some embodiments, the training terminal itself may be responsible for implementing a certain model parallel scheme (such as pipeline parallelism, tensor parallelism, or the like). In such cases, model training adopts hybrid parallelism. In some embodiments, after the model is trained with each batch of training data, a weighted average of respective training losses of the training terminals is calculated to obtain a weighted training loss for such batch. Afterwards, each training terminal updates a parameter of its local model using the weighted training loss for such batch to obtain a new version of the local model. In a case that the updated new version of the local model meets a convergence condition, the training is terminated. Otherwise, the training would continue iteratively. The weighted average may be calculated separately at each training terminal or may be calculated at an aggregating terminal, which is not limited herein.

In some embodiments, training data in the training data set is distributed among the training terminals participating in the training to conform to data parallelism. For every batch of training data, each training terminal determines its own training data according to the data distributed to it.

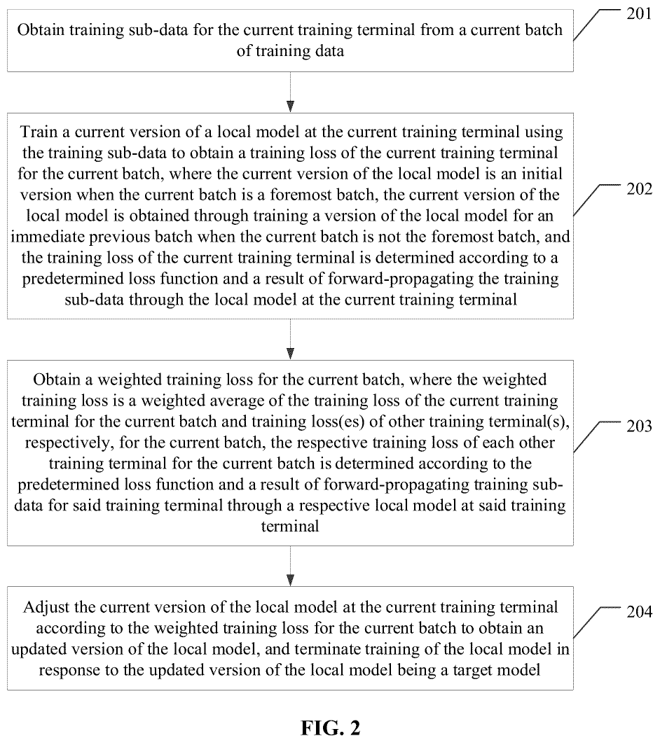

Reference is made to FIG. 2. In an embodiment, a method for training a model based on data parallelism may be implemented using the above architecture. The method comprises following steps of 201 to 204.

In step 201, training sub-data for the current training terminal is obtained from a current batch of training data.

For the sake of clear illustration, the current training terminal refers to an arbitrary training terminal participating in the training based on data parallelism, and the training terminal(s) participating in the training other than the current training terminal is called “other training terminal(s)”. Hereinafter, the method would be first described from the perspective of the current training terminal. Since any training terminal may utilize the method in this embodiment and/or related embodiment(s) to achieve more efficient model training, each training terminal participating in the training based on data parallelism may serve as the current training terminal.

Generally, when training a model having a tremendous quantity of parameters, training data in a training data set are distributed among the training terminals. For example, a certain batch (or mini-batch) of training data is directly transmitted to the training terminals. Alternatively, multiple batches of training data are transmitted together to the training terminals, and each training terminal picks its training sub-data in a per-batch manner from the training data distributed to it. Thereby, computational parallelism can be improved in model training.

Hence, for the current training terminal, the training sub-data for the current batch needs to be obtained before the model is trained with the current batch of training data.

In step S202, a current version of a local model at the current training terminal is trained using the training sub-data to obtain a training loss of the current training terminal for the current batch.

The obtained training sub-data for the current batch may be inputted into the current version of the local model at the current training terminal and forward-propagated, and a result of the forward propagation is the training loss of the current training terminal for the current batch. Detailed operations in this step may refer to conventional means of obtaining a training loss, which would not be illustrated herein.

In a broad sense, a process of model training comprises forward propagation, loss calculation, backward propagation, and parameter update (or model update). The training in this step is interpreted in a narrow sense, that is, it refers to forward propagation and loss calculation.

In step 203, a weighted training loss for the current batch is obtained, where the weighted training loss is a weighted average of respective training losses of multiple training terminals for the current batch.

Here the multiple training terminals comprise the current training terminal. The respective training loss of each training terminal is determined according to a predetermined loss function and a result of forward-propagating respective training sub-data of such training terminal through a current version of a respective local model at such training terminal. The current version of the local model is an initial version when the current batch is a foremost batch, and the current version of the local model is obtained through training an immediate previous version of the local model using an immediate previous batch of training data. In other words, the local model at each training terminal may be a universal initial model before being trained with the foremost batch of training data.

A weight of the respective training loss of each training terminal may be determined according to a volume of the training sub-data of such training terminal for the current batch. For example, the weight is positively correlated with the data amount. When the weights are identical across all training terminals, calculating the weighted average is equivalent to calculating a mean.

For example, there are two training terminals participating in the training. The current training terminal trains with 60 samples for the current batch, while the other training terminal trains with 40 samples for the current batch. When the weight average determines the data amount, the weighted training loss for the current batch is equal to 0.6 times the training loss of the current training terminal for the current batch plus 0.4 times the training loss of the other training terminal for the current batch. When the weights are equal, the weighted training loss for the current batch is equal to 0.5 times the training loss of the current training terminal for the current batch plus 0.5 times the training loss of the other training terminal for the current batch.

In step 204, the current version of the local model at the current training terminal is adjusted according to the weighted training loss for the current batch to obtain an updated version of the local model at the current training model, and training of the local model at the current training terminal is terminated in response to the updated version of the local model at the current training terminal being a target model.

The obtained weighted training loss for the current batch is backpropagated, and parameter(s) of the local model are updated according to a result of the backward propagation to obtain the new version of the local model. When the new version of the local model meets a requirement, the local model is determined to be the target model, and the iterative training is terminated.

In conventional training scheme using data parallelism, such as the all-reduce scheme, the obtained gradients of each layer in the entire model are collected, aggregated, and averaged, for one or more times through message passing interface (MPI) techniques during the training with each batch of training data. In comparison, herein it is not the gradients, but the training losses (i.e., values obtained through the loss function) of the local models obtained through forward propagation, that are averaged for each batch of training data. Each time the training synchronization occurs, only one piece of data, i.e., the training loss, is transmitted. Since the conventional training schemes need to transfer obtained model parameters or gradients that usually comprise hundreds of millions of pieces of data, embodiments of the present disclosure can achieve higher training synchronization efficiency and higher accuracy. Data synchronization efficiency is also efficiently improved.

Moreover, embodiments of the present disclosure achieve at least the following effects.

First, time is significantly saved. The large models have tremendous parameters (up to thousands or hundreds of billions of parameters), hence a huge amount of data needs to be transmitted (approximately, 2×quantity of training terminals×quantity of parameters×2, depending on which optimization algorithm is used) through network(s). Accordingly, network transmission becomes the key bottleneck in performances of the model training. In comparison with the conventional scheme, the amount of data required to be transmitted in embodiments of the present disclosure is reduced to a level of one billionth or one ten billions and even can be ignored (approximately, 2×quantity of training terminals×4). Overall efficiency of training the large models is greatly improved.

Second, the cost of hardware is greatly reduced. In a first aspect, the conventional schemes using data parallelism require dedicated network transmission devices and network transmission techniques having high performance, such as RDMA network, to achieve transmission of a large amount of data in a short time. In embodiments of the present disclosure, common networks may be utilized since only a small amount of data needs to be transmitted. In a second aspect, the conventional schemes usually require a separate parameter server due to a huge amount of calculation in averaging the parameters. In embodiments of the present disclosure, a common computing device may be utilized because the amount of calculation is also small.

Third, the main approach of optimizing the conventional scheme using data parallelism is the parallelism between calculation and transmission. That is, the averaging of gradients of a certain layer is performed at the same time when calculating gradients of an immediate previous layer. The above synchronization shall be applied to every two adjacent layers of the local model at each training terminal. Even if hardware configuration is exactly the same throughout the training terminals, calculation with respect to each layer does not cost exactly identical time among the respective local models at all training terminals. Hence, configuration of synchronization points would force the local model(s) of some training terminal(s) to stay in a waiting state during calculation for each layer. In embodiments of the present disclosure, only one synchronization point is required to average the training losses of the local models at the training terminals, and the local model of each training terminal runs independently and is trained independently at other moments. Thereby, the whole scheme is simpler and costs less time.

Fourth, the design of the software system is significantly simplified, and the costs of development and operation of the software system are significantly reduced. In the conventional schemes, the gradients of multiple operators in multiple training terminals shall be transmitted and synchronized. Thus, the design is extremely complicated, and the costs of development and operation are extremely high. In embodiments of the present disclosure, the scheme may be achieved by modifying a common training scheme, and special software system is not necessary.

Fifth, the scheme proposed herein is easy to integrate with other schemes. All conventional large models can be treated as a hybrid of a certain data parallelism scheme and a certain model parallelism scheme, and the data parallelism scheme is difficult to integrate with another model parallelism scheme due to complexities of both parallelism implementations. In embodiments of the present disclosure, the scheme may achieve a hybrid deployment with the model parallelism scheme with almost zero modification on the latter.

In some embodiments, the current training terminal obtaining the weighted training loss for the current batch may comprise, but is not limited to, following steps. The current training terminal transmits the training loss of the current training terminal for the current batch to a first aggregating terminal, and then receives the weighted training loss for the current batch from the first aggregating terminal, where the weighted training loss for the current batch is calculated by the first aggregating terminal. Alternatively, the current training terminal receives the training loss(es) from the other training terminal(s), respectively, and then calculates the weighted average of the training losses of the multiple training terminals for the current batch to obtain the weighted training loss for the current batch.

The difference between the above two manners lies in whether the process of calculating the weighted training loss for the current batch occurs in the training terminal (e.g., the current training terminal) or in the first aggregating terminal. In the former case, the current training terminal needs to receive the training loss for the current batch transmitted from each other training terminal. Generally, since the data volume of the training loss is extremely small (such as several hundreds of bytes), the above two manners both consume little time, and hence selection may be made on requirement.

In some embodiments, parameters of the local models of the multiple training terminals may be aggregated under a certain condition to obtain an aggregation parameter, and the local model of each training terminal is updated using the aggregation parameter. Efficiency of training the initial model can be improved to obtain an accurate target model more rapidly. The method may comprise following steps. When determining that the current training terminal meets a predetermined aggregation condition, a parameter of the local model at the current training terminal is transmitted to a second aggregating terminal, and the parameter is overwritten using an aggregation parameter transmitted from the second aggregating terminal to obtain an updated local model at the current training terminal. The aggregation parameter is obtained by the second aggregating terminal through calculating a weighted average of respective parameters of the local models at the multiple training terminals.

Different from the training loss, the model parameter is usually very large. Hence, when calculating the aggregation parameter, an aggregating terminal (such as the second aggregating terminal) is utilized to ensure efficiency of parameter aggregation. The predetermined aggregation condition may be that a quantity of epochs that have elapsed reaches a threshold for triggering system aggregation, a quantity of batches of training data that have been used by the training terminals reaches a threshold for triggering system aggregation, or a quantity of pieces of training data (e.g., a quantity of training samples) used by each training terminal is identical, which is not limited herein.

In some alternative embodiments, when determining that a training terminal (such as the current training terminal or another training terminal) meets the predetermined aggregation condition, the local model at each training terminal may be tested using a test data set to obtain a model evaluation index. The local model having the best test performance is determined according to the respective model evaluation index of each local model. The parameter of the local model having the best test performance is determined to serve as the aggregation parameter, and each training terminal overwrites the parameter of its own local model using the aggregation parameter. Efficiency of training the initial model can be improved to obtain an accurate target model more rapidly.

Both the first aggregating terminal and the second aggregating terminal are the aggregating terminals. The first aggregating terminal and the second aggregating terminal may be the same or different, which is not limited herein.

Hereinafter examples are provided to illustrate effects of the scheme according to embodiments of the present disclosure.

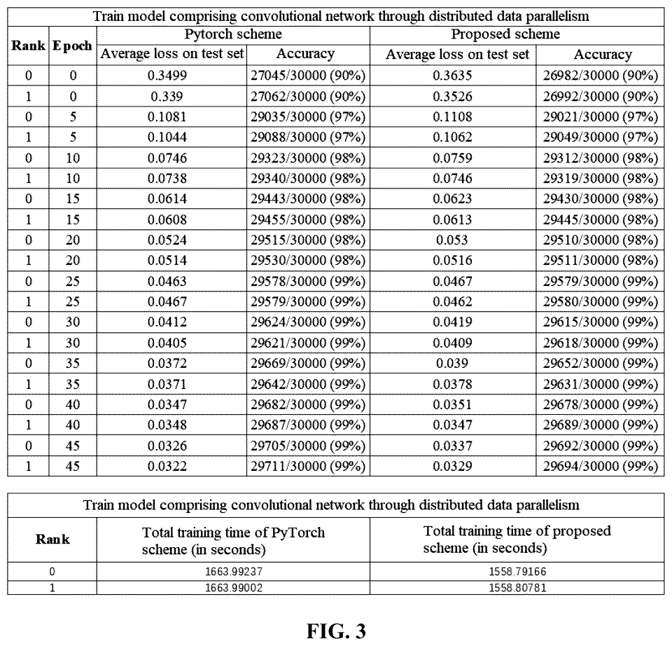

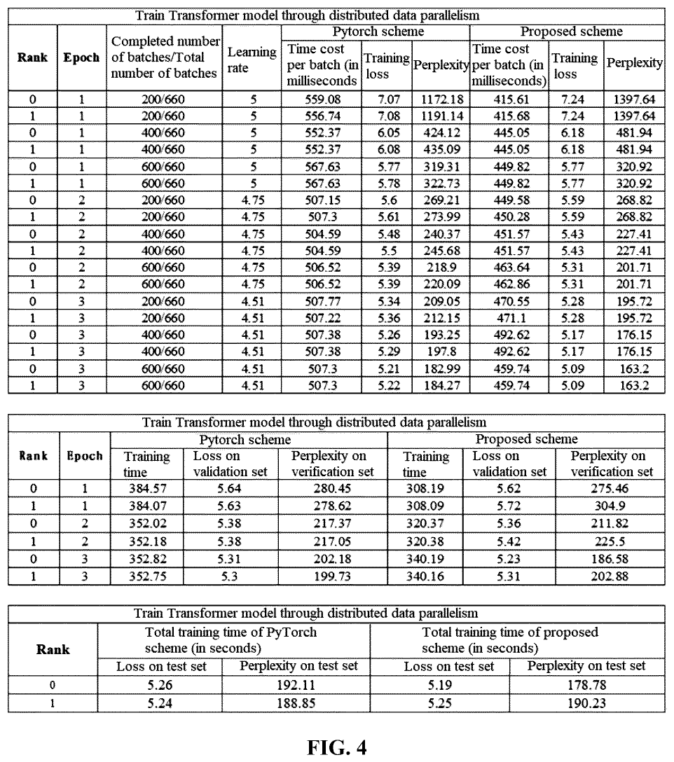

The PyTorch scheme and the scheme according to embodiments of the present disclosure (hereinafter “proposed scheme”) are taken as two comparative structure of data parallelism, and the PyTorch scheme and the proposed scheme are applied to train a model having convolutional networks and train the Transformer model, in order to better illustrate the effect on different networks or models. Evaluation metrics of the above training are shown in FIG. 3 and FIG. 4. Since large models with billions of parameters require extremely high training costs, the network or model trained herein have not too many parameters, such that the training can be implemented through multiple processes of a computer. As illustrated hereinafter, using fewer parameters does not affect illustrating the technical effect of the proposed scheme.

In FIG. 3, “rank” represents a sequential number of a training terminal. In the examples, “1” and “1” are two different processes simulating two training terminals. “Epoch” refers to a training cycle, and the convolutional network performs a complete learning cycle using the entire training set in each epoch. “Average loss on test set” refers to an average loss of the convolutional network processing a test set, where a smaller average loss value indicates a better performance of the convolutional network. “Accuracy” refers to accuracy of the trained convolutional network achieved on the test set, where the value on left of the slash symbol is a quantity of correct classifications, and the value on right of the slash symbol is a total quantity of classifications.

FIG. 3 shows comparison of a convergence speed and total time of training the model comprising the convolutional network with a small number of parameters (about 2,000 parameters) between the PyTorch scheme and the proposed scheme. According to the accuracy of the two schemes achieved with the same quantity of epochs, the converging speeds of the two schemes are similar. Even in such a small convolutional network, the total training time of the proposed scheme is much smaller than that of the PyTorch scheme. In the example as shown in FIG. 3, the two schemes adopt the same learning rate, and the proposed scheme does not utilize the periodical parameter synchronization (i.e., the above weighted averaging on the parameters) to obtain the aggregation parameter for updating the local models.

In FIG. 4, “rank” represents a sequential number of a training terminal. In the examples, “0” and “1” are two different processes simulating two training terminals. “Epoch” refers to a training cycle, and the Transformer model performs a complete learning cycle using the entire training set in each epoch. “Completed batches/total batches” refers to a quantity of batches that have already passed in the current training versus a total quantity of batches. “Time cost per batch” refers to time consumed by training with a single batch. “Training loss” refers to a loss of the model on the training set. “Perplexity” is a metric indicating performance of a language model, where smaller perplexity indicates a better model. “Loss on validation set” refers to a loss of the trained model on a validation set. “Perplexity on verification set” refers to the perplexity of the trained model on the verification set and indicates a general performance of the model. “Loss on test set” represents a loss of the trained model on the test set. “Perplexity on test set” represents the perplexity performance of the trained model on the test set.

FIG. 4 shows comparison of an effect of training the Transformer model using the Penn TreeBank corpus between the PyTorch scheme and the proposed scheme. In the example corresponding to FIG. 4, the two schemes also adopt the same learning rate, and each time 200 batches of training data are used, the proposed scheme performs the periodical parameter synchronization to obtain the aggregation parameter for updating the local model. As shown in FIG. 4, the converging speeds of the two schemes are similar. Even in such a small model (having about 6 thousand parameters), time cost per batch of the proposed scheme is much smaller than that of the PyTorch scheme. Although the convergence speed of the proposed scheme seems to be slightly lower than that of the PyTorch scheme, the accuracy of the target model obtained by the proposed scheme is higher than that of the target model obtained by the PyTorch scheme.

In the examples as shown in FIG. 3 and FIG. 4, multiple processes are used to simulate the multiple training terminals, and the multiple training terminals exchange their training losses through inter-process communication inside the single computing device to determine the weighted training loss for each batch. The time consumed by inter-process communication is far less than time consumed by network communication between different devices (such as servers or computer devices) in actual training scenarios. Hence, since the proposed scheme shows its advantage in training efficiency even in scenarios with fewer parameters, such advantage would be more apparent when training large models having thousands or hundreds of billions of parameters across computing devices.

The above examples also show that the proposed scheme could be applicable to all networks and all models, e.g., the convolutional network for image processing and the Transformer model suitable for natural language processing. The proposed scheme achieves similar training convergence speed and similar final training accuracy and consumes less training time in view of the conventional schemes using data parallelism. In summary, the method provided herein improves the training efficiency, shortens the training time, and achieves model performance not worse than the PyTorch scheme. Hence, it is very useful in practice.

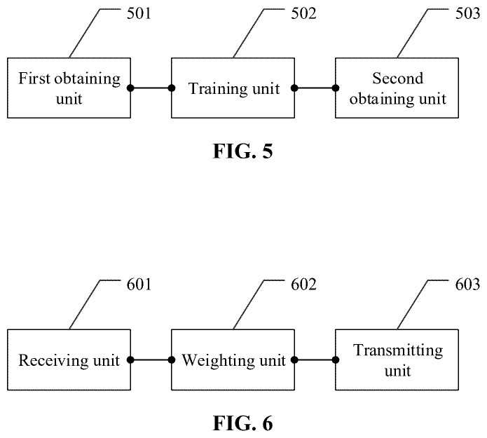

Reference is made to FIG. 5. A training terminal is provided according to an embodiment of the present disclosure. The training terminal comprises a first obtaining unit 501, a training unit 502, and a second obtaining unit 503.

The first obtaining unit 501 is configured to obtain training sub-data for the current training terminal from a current batch of training data.

The training unit 502 is configured to train a current version of a local model at the current training terminal using the training sub-data to obtain a training loss of the current training terminal for the current batch. The current version of the local model is an initial version when the current batch is a foremost batch, and the current version of the local model is obtained through training an immediate previous version of the local model using an immediate previous batch of training data when the current batch is not the foremost batch. The training loss of the current training terminal is determined according to a predetermined loss function and a result of forward-propagating the training sub-data through the current version of the local model at the current training terminal.

The second obtaining unit 503 is configured to obtain a weighted training loss for the current batch. The weighted training loss is a weighted average of the training loss of the current training terminal for the current batch and training loss(es) of other training terminal(s), respectively, for the current batch. The respective training loss of each other training terminal for the current batch is determined according to the predetermined loss function and a result of forward-propagating respective training sub-data for such training terminal through a current version of a respective local model at such training terminal.

The training unit 502 is further configured to adjust the current version of the local model at the current training terminal according to the weighted training loss for the current batch to obtain an updated version of the local model at the current training model. The training unit 502 is further configured to terminate training of the local model at the current training terminal in response to the updated version of the local model at the current training terminal being a target model.

In some embodiments, the second obtaining unit 503 is configured to: transmit the training loss of the current training terminal for the current batch to a first aggregating terminal, and receive the weighted training loss for the current batch from the first aggregating terminal, where the weighted training loss for the current batch is calculated by the first aggregating terminal. Alternatively, the second obtaining unit 503 is configured to: receive the training loss(es) from the other training terminal(s), respectively, and calculate the weighted average of the training loss of the current training terminal for the current batch and the training loss(es) to obtain the weighted training loss for the current batch.

In some embodiments, the training unit is further configured to: transmit, before terminating the training of the local model and in response to determining that the current training terminal meets a predetermined aggregation condition, a parameter of the local model at the current training terminal to a second aggregating terminal, and overwrite the parameter using an aggregation parameter transmitted from the second aggregating terminal to obtain an updated local model at the current training terminal. The aggregation parameter is obtained by the second aggregating terminal through calculating a weighted average of the parameter of the local model at the current training terminal and respective parameter(s) of the local model(s) at the other training terminal(s).

Reference is made to FIG. 6. An aggregating terminal is provided according to an embodiment of the present disclosure. The aggregating terminal includes a receiving unit 601, a weighting unit 602, and a transmitting unit 603.

The receiving unit 601 is configured to receive, from each of training terminals, a training loss of such training terminal for a current batch of training data. The training loss of each training terminal for the current batch is obtained by training a current version of a respective local model at such training terminal using respective training sub-data of such training terminal, and the respective training sub-data of each training terminal is from the current batch of training data.

The current version of the local model is an initial version when the current batch is a foremost batch, and the current version of the local model is obtained through training an immediate previous version of the local model using an immediate previous batch of training data when the current batch is not the foremost batch.

The weighting unit 602 is configured to calculate a weighted average of the training losses of the training terminals to obtain a weighted training loss for the current batch.

The transmitting unit 603 is configured to transmit the weighted training loss for the current batch to each of the training terminals to enable such training terminal to adjust the respective local model using the weighted training loss for the current batch and terminate training of the respective local model in response to the respective local model being a target model.

In an embodiment, the receiving unit 601 is further configured to receive, from each of the training terminals, a parameter of the respective local model of such training terminal.

The weighting unit 602 is further configured to calculate a weighted average of the parameters of the respective local models at the training terminals to obtain an aggregation parameter.

The transmitting unit 603 is further configured to transmit the aggregation parameter to each of the training terminals to enable said training terminal to overwrite the parameter of the respective local model using the aggregation parameter to obtain a respective updated local model.

Hereinabove described is a scheme in which a loss obtained from a predefined loss function of a network at the training terminal is backpropagated, and such scheme may be applied to a novel model training framework provided according to embodiments of the present disclosure. In the new framework, the multiple training terminals share at least one layer of, for example, a large model. That is, each layer of network in the large model runs either in a single instance or in L instances. Hereinafter a method for training a model under the new framework is provided according to an embodiment of the present disclosure. The loss backpropagation scheme at the last layer is combined with the new training framework.

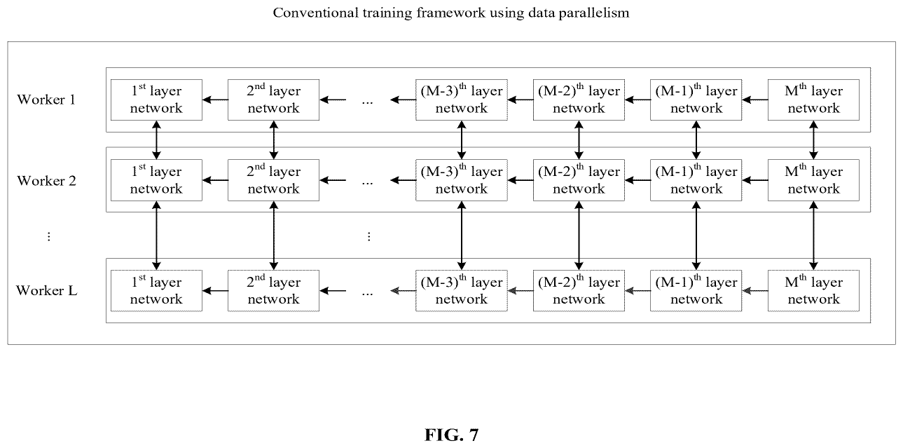

Reference is made to FIG. 7. In conventional schemes using data parallelism or hybrid parallelism, during back propagation and parameter update in the distributed training, it is necessary to aggregate the gradients for each layer of network among the multiple instances and return the averaged gradient to each instance. Such a process results in a large amount of data required to be transmitted among the multiple instances, and the parameter synchronization should be performed among the multiple instances for each layer of network in each training iteration. The parameter synchronization increases a waiting time and makes the system complicated.

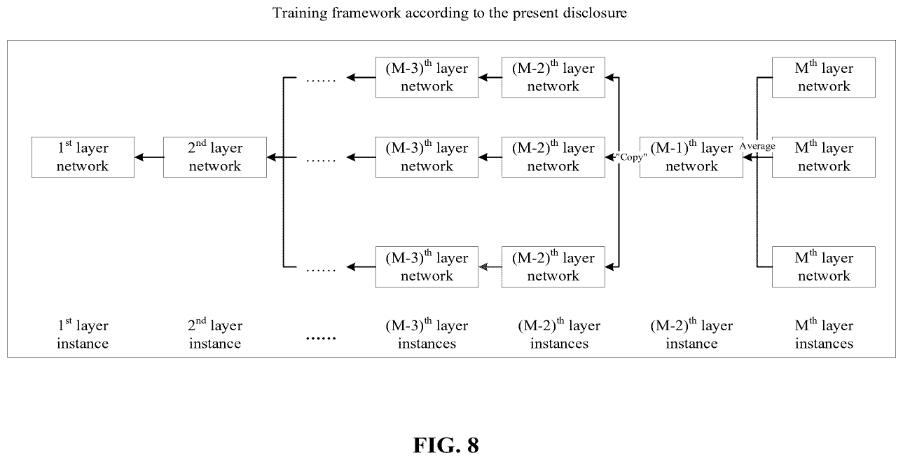

An improved training framework is provided according to an embodiment of the present disclosure. Reference is made to FIG. 8. When the training framework is utilized, multiple training terminals performing parallel training share some layer(s) of network (e.g., the 1^{st} layer network, the 2^{nd} layer network, and the (M−1)^{th} layer network, as shown in FIG. 8) of a model such as a large model. Hence, these layer(s) each is deployed as a single instance. Other layer(s) of network (e.g., the (M−3)^{th} layer network, the (M−2)^{th} layer network, and M^{th} layer network, as shown in FIG. 8) are distributed among the training terminals, i.e., on their respective instances.

At each training terminal, the above “other layer(s)” may be deployed among one or more instances, which is not limited herein.

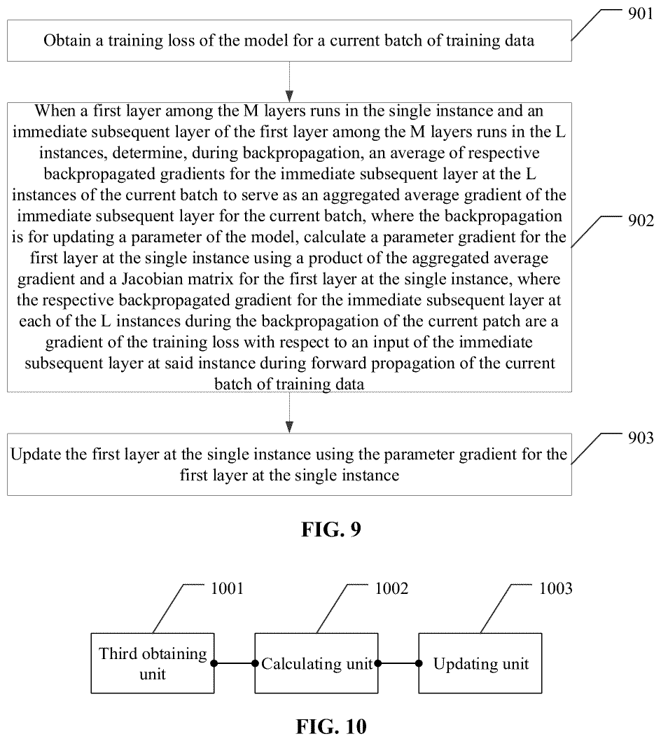

Reference is made to FIG. 9. A method for training a model is provided according to an embodiment of the present disclosure, and the method for training a model is applied to a model comprising M layers of network, where each layer of network runs in a single instance or among L instances configured for said layer(s), and both M and L are integers greater than 1. The model may be a large model. The method comprises steps 901 to 903.

In step 901, a training loss of the model for a current batch of training data is obtained.

In practice, the model may be trained using multiple batches of training data. After training with each batch of training data, gradients of network parameters are calculated through backpropagation, and the network parameters are updated according to the gradients. Here the N^{th} batch (which is also called a current batch hereinafter) of training data is taken as an example for illustrating the training method. As a common practice in the field, the sequential numbers of the layers of network in the model increases along a direction of the forward propagation. That is, during the forward propagation, computation in the j^{th} layer (which may be called a “first” layer hereinafter) occurs before the (j+1)^{th} layer. During the back propagation, gradient computation and parameter update of the (j+1)^{th} layer gradient occurs before gradient computation and parameter update of the j^{th} layer gradient. Moreover, the forward gradient algorithm (Jacobian-vector product, JVP) and the backward gradient algorithm (vector-Jacobian product, VJP) may be adopted to calculate the gradient(s) of the network parameter(s) of each layer. Hereinafter the VJP, that is, VJ=P, is utilized to calculate the gradients of the j^{th} layer, where V is the gradient backpropagated from the (j+1)^{th} layer to the j^{th} layer, J is the Jacobian matrix of the j^{th} layer, and P is the gradient of the j^{th} layer. P may also be simply called as the gradient of the j^{th} layer. P is also the gradient backpropagated from the j^{th} layer to the (j−1)^{th} layer.

Since the model is a multi-layer network, the j^{th} layer may be an arbitrary layer among the M layers of the model.

In step 902, when a first layer (the j^{th} layer) among the M layers runs in the single instance and an immediate subsequent layer (the (j+1)^{th} layer) of the first layer among the M layers runs in the L instances, an average of respective backpropagated gradients of the immediate subsequent layer at the L instances is determined during backpropagation, which is for updating a parameter of the model, of the current batch to serve as an aggregation average gradient of the immediate subsequent layer for the current batch, and a gradient of the first layer at the single instance is calculated using a product of the aggregation average gradient and a Jacobian matrix of the first layer at the single instance. The respective backpropagated gradient of the immediate subsequent layer at each of the L instances during the backpropagation of the current patch is a gradient of the training loss with respect to an input (which is fed from the first layer) of the immediate subsequent layer at such instance during forward propagation of the current batch of training data. During the forward propagation, an output of the j^{th} layer at the single instance of the j^{th} layer serves as the input of the (j+1)^{th} layer at each of the L instances of the (j+1)^{th} layer. Hence, the respective backpropagated gradient of the immediate subsequent layer at each of the L instances during the backpropagation of the current patch is also of the training loss with respect to the output of the first layer at its single instance during the forward propagation of the current batch of training data.

Here the only instance of the j^{th} layer is a single instance shared by the multiple training terminals (e.g., layer parameters of the instance are shared by the local models of the training terminals), and the multiple instances of the (j+1)^{th} layer are separate instances owned by the training terminals, respectively. During the backpropagation for updating parameters, the backpropagated gradients of the multiple instances of the (j+1)^{th} layer needs to be aggregated and averaged to obtain the aggregation average gradient of the (j+1)^{th} layer as the input to the j^{th} layer to compute the gradient of j^{th} layer during backpropagation. Then, the product of the aggregation average gradient of the (j+1)^{th} layer for the current batch and the Jacobian matrix of the j^{th} layer at its single instance is calculated as the gradient of the j^{th} layer at its single instance.

In an embodiment, j is equal to M−1, and the correspondence relationship between the single instance of the j^{th} layer and the L instances of the (j+1)^{th} layer may refer to that between the (M-1)^{th} layer instance and the M^{th} layer instances as shown in FIG. 8. As indicated by the arrow between the M^{th} layer instances and the single (M-1)^{th} layer instance in FIG. 8, the gradient obtained by the (M-1)^{th} layer network from the M^{th} layer network is the aggregation average gradient, where the aggregation average gradient is an average of the backpropagated gradients of the M^{th} layer instances.

The backpropagated gradient of any layer of network refers to the gradient that such layer needs to transmit to its immediate previous layer when during updating gradients through the back propagation. The gradient of any layer refers to the gradient utilized by such layer when adjusting its own network parameter(s).

In step 903, the (parameter of) first layer (the j^{th} layer) at each instance of the first layer is updated using the gradient of the first layer at such instance.

As mentioned above, the gradient of any layer refers to the gradient utilized by such layer of the network when adjusting its own network parameter(s). Hence, a new parameter of the j^{th} layer at each instance of the j^{th} layer can calculated using the gradient of the j^{th} layer at such instance. Then, the parameter of the j^{th} layer at such instance is updated to be the new parameter. That is, parameter update of the j^{th} layer at such instance is completed.

In an embodiment, the multiple training terminals operate in parallel to implement the data parallelism. In a case that a certain layer requires a lot of memory storage resources but requires few computing resources, the training terminals may share a single instance to implement such layer. Thereby, it is avoided that separate instances of the training terminals occupy too many storage resources. Utilization rate of memory storage resources is effectively improved, and pressure on the GPU memory resources is reduced.

In an alternative case, the first layer (the j^{th} layer) among the M layers runs in the L instances and the immediate subsequent layer (the (j+1)^{th} layer) of the first layer among the M layers runs in the single instance. In such case, for the first layer at each of the L instances, a product of the backpropagated gradient of the immediate subsequent layer at the single instance and the Jacobian matrix of the first layer at such instance is calculated during backpropagation, which is for updating a parameter of the model, of the current batch to serve as a parameter gradient (hereinafter called a gradient for short) of the first layer at such instance.

Here the instances of the j^{th} layer are separate instances deployed at the multiple training terminals, respectively, and the only instance of the (j+1)^{th} layer is the single instance shared by the multiple training terminals. During the backpropagation for updating parameters, each instance of the j^{th} layer calculates its own gradient using the product of the backpropagated gradient of the single instance of the (j+1)^{th} layer and its own Jacobian matrix. The above process is equivalent to “copying” the backpropagated gradient of the single instance of the (j+1)^{th} layer to transmit to each instance of the j^{th} layer, such that each instance of the j^{th} layer is capable of calculating its gradient.

In an embodiment, j is equal to M−2, and the correspondence relationship between the L instances of the j^{th} layer and the single instance of the (j+1)^{th} layer may refer to that between the (M−2)^{th} layer instances and the (M−1)^{th} layer instance as shown in FIG. 8. As indicated by the arrow between the (M−1)^{th} layer instance and the (M−2)^{th} layer instances in FIG. 8, the gradient of the (M−1)^{th} layer network obtained by each (M−2)^{th} layer instance is the backpropagated gradient of the single (M−1)^{th} layer instance.

In an alternative case, the single instance in which the first layer (the j^{th} layer) among the M layers runs and the single instance in which the immediate subsequent layer (the (j+1)^{th} layer) of the first layer among the M layers runs corresponds to each other, or the L instances in which the first layer (the j^{th} layer) runs and the L instances in which the immediate subsequent layer (the (j+1)^{th} layer) runs are in one-to-one correspondence. In such case, a product of the backpropagated gradient of the immediate subsequent layer at each instance for the immediate subsequent layer and the Jacobian matrix of the first layer at a respective instance, which corresponds to said instance for the immediate subsequent layer, for the first layer is calculated during backpropagation, which is for updating a parameter of the model, of the current batch to serve as a gradient of the first layer at the respective instance.

Here a quantity of instances of the j^{th} layer is equal to a quantity of instances of the (j+1)^{th} layer, and there may be two cases. In a first case, the multiple instances of the j^{th} layer are separate instances owned by the multiple training terminal, respectively, the multiple instances of the (j+1)^{th} layer are separate instances owned by the multiple training terminal, respectively, and each instance of the j^{th} layer is connected to a respective instance of the (j+1)^{th} layer of the same training terminal. In a second case, the only instance of the j^{th} layer is shared by multiple training terminals, and the only instance of the (j+1)^{th} layer is shared by multiple training terminals.

In the first case, during the backpropagation for updating parameters, the backpropagated gradient of the (j+1)^{th} layer at its each instance is required to be transmitted only to the instance of the j^{th} layer that belongs to the same training terminal. Then, the instance of the j^{th} layer at each training terminal calculates the gradient of the j^{th} layer using the backpropagated gradient of (j+1)^{th} layer received from the corresponding instance of the (j+1)^{th} layer. In the first case, it is not necessary to aggregate and average the respective backpropagated gradients of the multiple instances of the (j+1)^{th} layer, and it is not necessary either to “copy” the backpropagated gradient of any instance of the (j+1)^{th} layer to transmit to the multiple instances of the j^{th} layer.

In an embodiment, j is equal to M−3, and the correspondence relationship between the L instances of the j^{th} layer and the L instances of the (j+1)^{th} layer may refer to that between the (M−3)^{th} layer instances and the (M−2)^{th} layer instance as shown in FIG. 8. As indicated by the arrows between the (M−2)^{th} layer instances and the (M−3)^{th} layer instances in FIG. 8, the gradient of the (M−2)^{th} layer network obtained by each (M−3)^{th} layer instance is the backpropagated gradient of the (M−2)^{th} layer instance corresponding to such (M−3)^{th} layer instance in the one-to-one correspondence.

In the second case, during the backpropagation for updating parameters, the single instance of the j^{th} layer calculates the gradient using the backpropagated gradient of the single instance of the (j+1)^{th} layer.

In an embodiment, j is equal to 1, and the correspondence relationship between the single instance of the j^{th} layer and the single instance of the (j+1)^{th} layer may refer to that between the 1^{st} layer instances and the 2^{nd} layer instance as shown in FIG. 8. As indicated by the arrows between the 2^{nd} layer instance and the 1^{st} layer instance in FIG. 8, the gradient of the 2^{nd} layer network obtained by the single 1^{st} layer instance is the backpropagated gradient of the single 2^{nd} layer instance.

In some embodiments, each layer running in the L instances, among the M layers, is determined to serve as a to-be-synchronized layer, in response to the model meeting a predetermined condition. For each to-be-synchronized layer, L to-be-synchronized parameters of such to-be-synchronized layer are obtained from the L instances, respectively, in which such to-be-synchronized layer runs, an aggregation parameter for such to-be-synchronized layer is determined according to the L to-be-synchronized parameters, and each of the L to-be-synchronized parameters is updated to be the aggregation parameter.

As described in the foregoing description, when the multiple instances of the j^{th} layer are separate instances owned by the training terminals, respectively, or the multiple instances of the (j+1)^{th} layer are separate instances owned by the training terminals, respectively, it is not limited that the network parameter(s) of the (j+1)^{th} layer are synchronized among the multiple training terminals. Hence, as an option on a basis of the foregoing embodiments, network parameters of the to-be-synchronized layers may be synchronized among different training terminals. In such case, a convergence speed of the model training may be improved. As an example, the (M−3)^{th} layer network, the (M−2)^{th} layer network, and the M^{th} layer network as shown in FIG. 8 are the to-be-synchronized layers.

Here in the multi-layer model, each layer not shared by the multiple training terminals is treated as the to-be-synchronized layer. The L to-be-synchronized parameters of the to-be-synchronized layer is obtained from the L instances in which such to-be-synchronized layer runs. Herein each “to-be-synchronized parameter” refers to all parameter(s) that are to be synchronized and are obtained from one of the L instances in which a corresponding to-be-synchronized layer runs. As shown in FIG. 8, the (M−3)^{th} layer network is a to-be-synchronized layer, and then all parameter(s) that are to be synchronized and are obtained from one of the (M−3)^{th} layer instance is one to-be-synchronized parameter of the (M−3)^{th} layer network.

Then, the L to-be-synchronized parameters corresponding to the to-be-synchronized layer are subjected to weighted aggregation to obtain the aggregation parameter of such to-be-synchronized layer. The weights corresponding to the L instances running such to-be-synchronized layer may be configured on requirement. For example, the weights corresponding to the instances may be identical or may be determined according to a quantity of training samples used by each instance in the current batch of training data, which is not specifically limited herein. Then, the respective to-be-synchronized parameters in the L instances in which the to-be-synchronized layer runs are updated to be the aggregation parameter of such to-be-synchronized layer.

In an embodiment, the M^{th} layer network runs in L M^{th} layer instances, the training terminal executing the above method is the current training terminal, the model is trained by the L training terminals on a basis of data parallelism, and the L training terminals comprises the current training terminal. The L training terminals share at least one layer of the M layers, and each layer shared by L training terminals runs in the single instance. In such case, step 901 may comprise a following sub-step. A weighted training loss for the current batch is determined to serve as the training loss of the model for the current batch of training data, where the weighted training loss for the current batch is a weighted average of respective training losses of the L training terminals for the current batch, and the respective training loss of each of the L training terminals for the current batch is determined according to a predetermined loss function and an output of the last layer at such training terminal during training the model with the current batch of training data. The training loss of the model for the current batch is similar to that has been described in the foregoing embodiments, such the embodiment corresponding to FIG. 2. Hence, calculation of the training loss may refer to the foregoing embodiments and would not be repeated herein.

The training loss of each training terminal for the current batch is determined according to the predetermined loss function and the output of the M^{th} layer network at such training terminal for the current batch. The output of the M^{th} layer network at each training terminal for the current batch is the output of the M^{th} layer instance deployed on the training terminal. The weighted training loss is the weighted average of the training losses of the L training terminals for the current batch. The respective weight of each training terminal may be determined according to the data amount of training sub-data used by each training terminal in the current batch of training data, and the weight is positively correlated with the data amount. A manner of determining weight is not limited to the above example. In a case that the weight of each training terminal is identical, calculating the weighted average is equivalent to calculating a mean.

Following schemes may be adopted to calculate the weighted training loss for the current batch. Each training terminal participating in the model training may receive the training losses of the other L−1 training terminals (i.e., the L training terminals except itself) for the current batch. Alternatively or additionally, a corresponding aggregating terminal receives the training losses of all training terminals.

When a model is trained under the training framework provided according to embodiments of the present disclosure, only two cases require the aggregation average, and synchronization occurs only in these two cases. In a first case, during forward propagation at each training terminal is completed, the aggregation average is performed on the training losses of multiple training terminals, and the averaged loss serves as the loss of each instance running the last layer of network. Then, the instance in each training terminal performs independent backward propagation and parameter updating. In a second case, during backpropagation and parameter updating, the aggregation average is performed on the backpropagated gradients transmitted to a single instance shared by the multiple training terminals. Therefore, compared with the convention training framework, the volume of data transmitted among the multiple instances and the waiting time for synchronization among multiple instances are greatly reduced, and complexity of the system is significantly reduced. The training efficiency is effectively improved.

When the L training terminals share the last layer network (e.g., the M^{th} layer network), the training losses for the current batch of all training terminals can only be obtained after all training terminals complete the forward propagation for the current batch. Afterwards, the weighted training loss for the current batch can be calculated.

Reference is made to FIG. 10. A training terminal is provided according to an embodiment of the present disclosure. The training terminal is applicable to a model comprising M layers of networks, where each layer of network runs in a single instance or among L instances configured for said layer, and both M and L are integers greater than 1. The model may be a large model. The training terminal comprises a third obtaining unit 1001, a calculating unit 1002, and an updating unit 1003.

The third obtaining unit 1001 is configured to obtain a training loss of the model for a current batch of training data.

The calculating unit 1002 is configured to, when a first layer among the M layers runs in the single instance and an immediate subsequent layer of the first layer among the M layers runs in the L instances: determine an average of respective backpropagated gradients of the immediate subsequent layer at the L instances during backpropagation, which is for updating a parameter of the model, of the current batch to serve as an aggregation average gradient of the immediate subsequent layer for the current batch; and calculate a gradient of the first layer at the single instance using a product of the aggregation average gradient and a Jacobian matrix of the first layer at the single instance. The respective backpropagated gradient of the immediate subsequent layer at each of the L instances during the backpropagation of the current patch is a gradient of the training loss with respect to an input of the immediate subsequent layer at such instance during forward propagation of the current batch of training data.

The updating unit 1003 is configured to update the first layer at the single instance using the gradient of the first layer at the single instance.

In an embodiment, the calculating unit 1002 is further configured to, when the first layer runs in the L instances and the immediate subsequent layer of the first layer runs in the single instance: determine, for the first layer at each of the L instances, a product of the backpropagated gradient of the immediate subsequent layer at the single instance and the Jacobian matrix of the first layer at such instance during backpropagation, which is for updating a parameter of the model, of the current batch to serve as a gradient of the first layer at such instance. The updating unit 1003 is further configured to update the first layer at each of the L instances using the gradient of the first layer at such instance.

In an embodiment, the calculating unit 1002 is further configured to, when the single instance in which the first layer runs and the single instance in which the immediate subsequent layer of the first layer runs correspond to each other, or when the L instances in which the first layer runs and the L instances in which the immediate subsequent layer runs are in one-to-one correspondence: determine a product of the backpropagated gradient of the immediate subsequent layer at each instance for the immediate subsequent layer and the Jacobian matrix of the first layer at a respective instance, which corresponds to such instance for the immediate subsequent layer, for the first layer during backpropagation, which is for updating a parameter of the model, of the current batch to serve as a gradient of the first layer at the respective instance. The updating unit is further configured to update the first layer at each instance for the first layer using the gradient of the first layer at such instance.

In an embodiment, the training terminal further comprises a determination unit configured to: determine each layer running in the L instances, among the M layers, to serve as a to-be-synchronized layer, in response to the model meeting a predetermined condition; and for each to-be-synchronized layer; obtain L to-be-synchronized parameters of said to-be-synchronized layer from the L instances, respectively, in which such to-be-synchronized layer runs; determine an aggregation parameter for such to-be-synchronized layer according to the L to-be-synchronized parameters; and update each of the L to-be-synchronized parameters to be the aggregation parameter.

In an embodiment, the model is trained in parallel by L training terminals comprising the training terminal, the L training terminals share at least one layer of the M layers, each of the at least one layer runs in the single instance, and a last layer of the M layers runs in the L instances distributed among the L training terminals, respectively. The third obtaining unit is configured to: determine a weighted training loss for the current batch to serve as the training loss of the model for the current batch of training data, where the weighted training loss for the current batch is a weighted average of respective training losses of the L training terminals for the current batch, and the respective training loss of each of the L training terminals for the current batch is determined according to a predetermined loss function and an output of the last layer at such training terminal during training the model with the current batch of training data.

In an embodiment, the weighted training loss is calculated by one of the L training terminals, or by an aggregating terminal, according to the respective training losses of the L training terminals for the current batch.

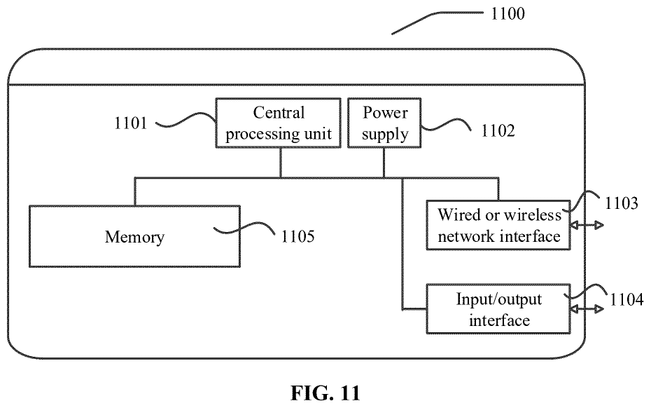

Reference is made to FIG. 11, which shows a schematic structural diagram of a computer device according to an embodiment of the present disclosure. The computer device 1100 may comprise one or more central processing units (CPUs) 1101 and a memory 1105 in which one or more application programs or data are stored.

The memory 1105 may be a volatile memory or a persistent memory. The program stored in the memory 1105 may comprise one or more modules, and each of the modules may comprise a series of instructions executable in the computer device. Further, the central processing unit 1101 may be configured to communicate with the memory 1105 and may execute the series of instruction operations stored in the memory 1105 in the computer device 1100.

The computer device 1100 may further comprise one or more power supplies 1102, one or more wired or wireless network interfaces 1103, one or more input/output interfaces 1104, and/or, one or more operating systems such as Windows Server™, Mac OS X™, Unix™, Linux™, or FreeBSD™.

The central processing unit 1101 may implement operations which are performed by the current training terminal or the aggregating terminal in the embodiments as shown in FIGS. 1 to 6, and/or perform operations executed by the training terminal in the embodiments as shown in FIGS. 7 to 10. These operations would not be repeated herein.

Although the steps in the flowcharts related to each embodiment are drawn according to an order as indicated by arrows, execution of these steps is not strictly limited to such order unless explicitly stated herein, and these steps may be executed in another sequence. At least a part of the steps in the flowchart comprises multiple sub-steps or stages, and these sub-steps or stages are not necessarily executed at the same time but may be executed at different moments. A sequence of executing these sub-steps or stages is not necessarily sequential, instead, they may be executed in turn or alternately with other steps or with at least a part of sub-steps or stages in other steps.

For the sake of conciseness and brevity, specific working processes of the system, device and unit described herein may refer to the processes in the corresponding method embodiments and would not be repeated herein.

In some embodiments of the present disclosure, the disclosed system, device, or method may be implemented in another manner. The embodiments of the aforementioned device may be schematic. For example, the division of the units is only based on logical functions, and there may be other division manners in actual implementation. For example, multiple units or components may be combined or integrated into another system, or some features may be ignored or not be executed. In addition, the couplings and communication connections shown or discussed herein may be direct or indirect couplings or communication connections implemented via some interface, device, or unit, and may be electrical, mechanical or in other forms.

The units described as separate components may be or may not be separated physically. The component displayed as a unit may be or may not be a physical unit, that is, it may be located at one place or may be distributed among multiple network units. Some or all of the units may be selected according to an actual requirement to achieve an objective of the scheme disclosed herein.

In addition, the functional units in embodiments of the present disclosure may be integrated into one processing unit, or each of the units may exist alone physically, or two or more of the units may be integrated into one unit. The above integrated units may be implemented as hardware or software functional units.

In a case that the integrated unit is implemented as a software functional unit and sold or used as an independent product, the integrated unit may be stored in a computer readable storage medium. On a basis of such understanding, all or a part of an essence or a portion contributing over the conventional technology in the technical scheme provided herein may be embodied as a software product. The computer software product is stored in a storage medium and comprises instructions to cause a computer device (which may be a personal computer, a server, a network device, or the like) to perform all or a part of the steps of the various method embodiments of the present disclosure. The foregoing storage medium includes: a U disk, a removable hard disk, a read-only memory (ROM), a random-access memory (RAM), a magnetic disk, an optical disk, or other media that can store program codes.

A computer program product comprising instructions is further provided according to an embodiment of the present disclosure. The computer program product, when running on a computer, causes the computer to execute the method according to any foregoing embodiment.

1. A method for training a model based on data parallelism, wherein the model comprises local models trained at training terminals, respectively, and the method comprises:
obtaining, by a first terminal, respective training losses of the training terminals; and
calculating, by the first terminal, a weighted average of the training losses to obtain a weighted training loss, wherein the weighted training loss is for updating a parameter of the local model trained at each of the training terminals.

2. The method according to claim 1, wherein each of the training terminals obtains the respective training loss of said training terminals through:
training a current version of the local model at said training terminal using training sub-data of said training terminal, wherein:
the training sub-data is a part of a current batch of training data, and
the training loss of said training terminal is determined according to a predetermined loss function and a result of forward-propagating the training sub-data of said training terminal through the current version of the local model at said training terminal.

3. The method according to claim 2, wherein:
the first terminal is one of the training terminals;
obtaining the respective training losses of the training terminals comprises:
receiving the training sub-data of the first terminal;
training the current version of the local model at the first terminal using the training sub-data of the first terminal to obtain the training loss of the first terminal; and
receiving, from the training terminals other than the first terminal, the respective training losses of the training terminals other than the first terminal; and
the method further comprises:
adjusting the current version of the local model at the first terminal with backpropagation according to the weighted training loss to obtain an updated version of the local model at the first terminal.

4. The method according to claim 3, further comprising:
in response to determining that the current training terminal meets a predetermined aggregation condition,
transmitting a parameter of the local model at the first terminal to an aggregating terminal,
receiving an aggregated parameter transmitted from the aggregating terminal, wherein the aggregated parameter is a weighted average of respective parameters of all the local models, and the parameter of the local model at the first terminal is one of the parameters, and
overwriting the parameters of the local model at the first terminal using the aggregated parameter.

5. The method according to claim 2, wherein:
the first terminal is an aggregating terminal different from the training terminals; and
obtaining the respective training losses of all the training terminals comprises receiving, from all the training terminals, the respective training losses of the training terminals; and
the method further comprises:
transmitting the weighted training loss to each of the training terminals to enable said training terminal to adjust the current version of the local model at said training terminal according to the weighted training loss to obtain an updated version of the local model at said training terminal.

6. The method according to claim 5, further comprising:
receiving, from each of the training terminals, a respective parameter of the local model at said training terminal;
calculating a weighted average of the respective parameters of all the local models at the training terminals to obtain an aggregated parameter; and
transmitting the aggregation parameter to each of the training terminals to enable said training terminal to overwrite the respective parameter of the local model at said training terminal using the aggregated parameter.

7. The method according to claim 1, wherein the model comprises a plurality of network layers, a first layer among the plurality of network layers is deployed among respective first instances of the training terminals, and the method comprises:
obtaining respective backpropagated gradients of the first layer at the first instances of the training terminals; and
calculating a weighted average of the backpropagation gradients to obtain a weighted gradient, wherein the weighted gradient is for calculating a gradient of a second layer among the plurality of network layers, the second layer is an immediately previous layer of the first layer along a direction of forward propagation, and the second layer is deployed on a single second instance of which layer parameters are shared by the local models of all the training terminals.

8. The method according to claim 7, wherein the respective backpropagation gradient of the first layer at the first instance of each of the training terminals is a gradient of the weighted training loss with respect to:
an input of the first layer at the first instance of said training terminal during forward propagation of the training sub-data of said training terminal through current version of the local model at said training terminal, wherein the input of the first layer is fed from the second layer.

9. The method according to claim 7, wherein:
the gradient of the second layer is calculated through calculating a product of the weighted gradient and a Jacobian matrix of the second layer; and
updating the parameter of the local model trained at each of the training terminals comprises: updating a parameter of the second layer using the gradient of the second layer at the single second instance.

10. The method according to claim 7, wherein:
the plurality of network layer further comprises a third layer and a fourth layer, the fourth layer is an immediately previous layer of the third layer in the direction of forward propagation, the third layer is deployed on a single third instance of which layer parameters are shared by the local models of all the training terminals, and the fourth layer is deployed among respective fourth instances of the training terminals, and the method further comprises:
calculating a gradient of the fourth layer at the fourth instance of each of the training terminals according to a backpropagated gradient of the third layer;
wherein the backpropagated gradient of the third layer is a gradient of the weighted training loss with respect to an input of the third layer during forward propagation of the current batch of training data.

11. The method according to claim 10, wherein:
the gradient of the fourth layer at the fourth instance of each of the training terminals is calculated at the fourth instance of said training terminal through calculating a product of the backpropagated gradient of the third layer and a Jacobian matrix of the fourth layer at the fourth instance of said training terminal; and
the method further comprises:
updating a parameter of the fourth layer at the fourth instance of each of the training terminals using the gradient of the fourth layer at the fourth instance of said training terminal.

12. The method according to claim 10, wherein the third layer is the second layer, and the single third instance is the single second instance.

13. A terminal, comprising:
a memory storing computer-readable instructions, and
a processor, wherein the computer readable instructions when executed by the processor implement a method comprising:
obtaining respective training losses of training terminals, wherein the training terminals are configured to train local models, respectively, of a model; and
calculating a weighted average of the training losses to obtain a weighted training loss, wherein the weighted training loss is for updating a parameter of the local model trained at each of the training terminals.

14. A non-transitory computer-readable storage medium, storing computer-readable instructions, wherein the computer readable instructions when executed by a processor implement a method comprising:
obtaining respective training losses of training terminals, wherein the training terminals are configured to train local models, respectively, of a model; and
calculating a weighted average of the training losses to obtain a weighted training loss, wherein the weighted training loss is for updating a parameter of the local model trained at each of the training terminals.
